(19) United States
(12) Patent Application Publication
(10) Pub. No.: US 2011/0288967 A1
(43) Pub. Date: Nov. 24, 2011

(54) Card-Based Banking

(75) Inventor: Stephen P. Selfridge, Huntersville, NC (US)

(73) Assignee: BANK OF AMERICA CORPORATION, Charlotte, NC (US)

(21) Appl. No.: 12/783,742

(22) Filed: May 20, 2010

(51) Int. Cl. G06Q 40/00; G06Q 10/00; G06Q 20/00

(52) U.S. Cl. 705/30; 705/40; 235/379

(57) ABSTRACT

A payment device may be issued that is user generic and allows for the payment of billing accounts by storing billing account information in association with the payment device and/or an underlying funding account. In one example, the payment device might not store any user identification information. Upon receiving a bill payment request, a bill payment device may retrieve bill payment account information from a remote financial institution system (e.g., for a financial institution holding the payment device funding account) or from the payment device. The bill payment accounts may then be displayed for user selection. Payments may then be electronically transferred to a payee associated with the bill payment account.

### BACKGROUND

Financial transactions are conducted in a variety of manners. For example, some individuals conduct financial transactions using currency (e.g., cash) while others use checks, while still others use electronic payment devices such as credit cards. For some individuals, the use of currency and checks may pose risks that may be better controlled through the use of cards or other payment devices. In one example, loss of currency and/or checks may result in the unrecoverable loss of funds. Cards and other payment devices, on the other hand, allow a user, upon losing the payment device, to terminate the payment device, thereby disallowing further transactions. Cards and other electronic payment devices may also offer more convenient management of an individuals finances and purchases since only one device or item is needed for all transactions (versus multiple currency denominations or different checks for different transactions).

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, financial transactions may be conducted using a user generic payment device such as a pre-paid card. A pre-paid card may be associated with a pre-funded account that does not provide any credit or overdraft protection. The user generic payment device and/or an underlying funding account may not store or be associated with personal user information. In one example, the payment device may be used to conduct bill payment transactions in which a user pays one or more service providers or retailers for an amount owed. The bill payment account information may be stored in association with the payment device (e.g., an identifier of the payment device or the like) and/or the underlying funding account. Accordingly, upon insertion or otherwise identifying the payment device to a transaction system, bill payment account information may be retrieved based on the payment device.

According to another aspect, a payment device may be created by depositing funds into an account and specifying one or more bill payment accounts to be stored in association with an underlying funding account of the payment device. The bill payment account information may be stored at the financial institution holding the underlying funding account, on the payment device, in the payment device issuing system and/or combinations thereof.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for processing financial transactions according to one or more aspects described herein.

FIG. 3 illustrates an example method for processing a bill payment request according to one or more aspects described herein.

FIG. 4 illustrates an example method for conducting financial transactions using a payment device according to one or more aspects described herein.

FIGS. 5A and 5B illustrate example user interfaces through which a user may perform a bill payment transaction according to one or more aspects described herein.

FIGS. 6A and 6B illustrate further example user interface through which a user may perform a bill payment transaction according to one or more aspects described herein.

FIG. 7 illustrates an example method for creating a payment device according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

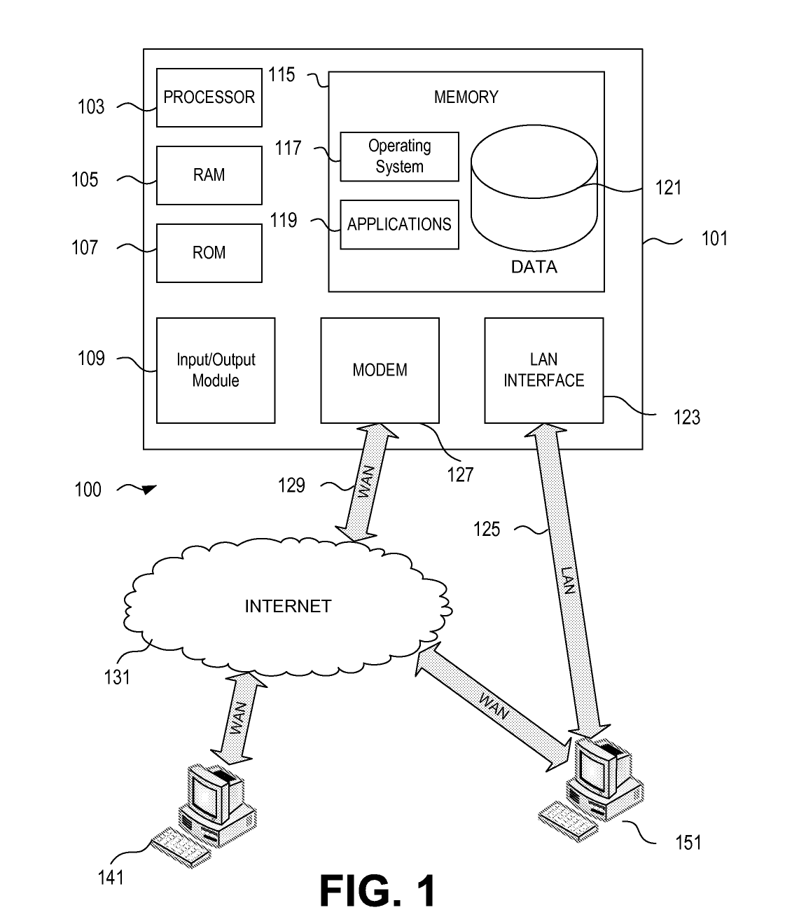

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

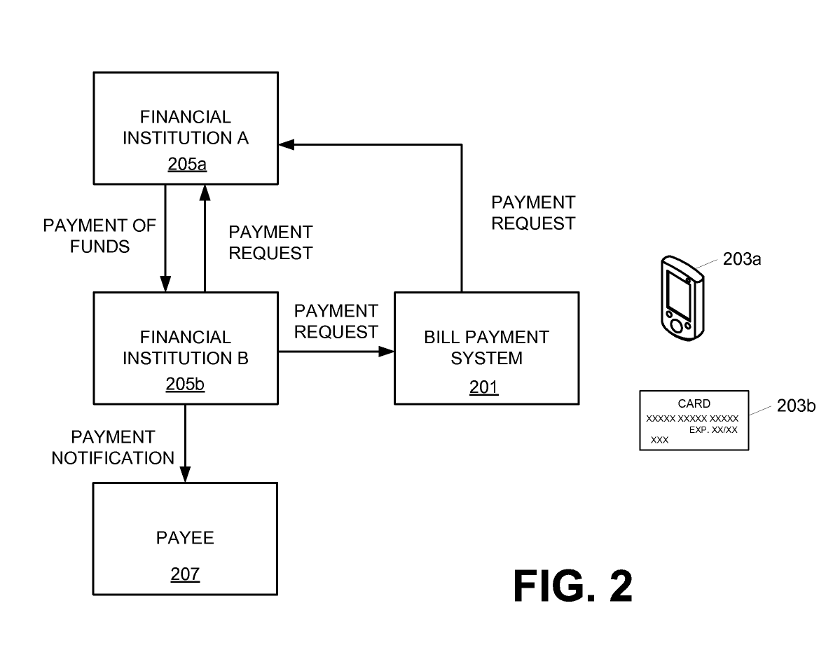

FIG. 2 illustrates a payment processing environment in which a consumer or customer may use a payment device such as devices 203 at a payment system, such as bill payment system 201, to pay one or more bills or purchase products or services. For example, a user may approach a bill payment kiosk (e.g., system 201) in order to pay an electric bill issued by payee 207. The user may choose to use a pre-paid, check or credit card 203b or another payment device such as a mobile communication device 203a (e.g., a cell phone). In one or more arrangements, the bill payment system may retrieve bill payment accounts and information associated therewith from a financial institution such as financial institution A 205a backing the funding account associated with the payment device being used. The funding account may be identified based on an account number stored in card 203b or other payment device 203a. The account number may be determined from card 203b or other payment device 203a when, for instance, a user inserts card 203b into, or otherwise interacts with, bill payment system 201 (e.g., placing card 203b in contact with or within a predefined proximity of system 201). Retrieving the bill payment accounts from a financial institution such as institution 205a may be performed based on the account number. In one or more arrangements, a payment device identifier, account number and the underlying funding account may be user generic. That is, the account might not store any personal user information that directly identifies the user. For example, personal user identification information may include as age, birthdate, name, social security number, address or other contact information and the like. While a bill payment account number may identify a user, the identification is typically indirect. In particular, an individual would need to access the account specified by the bill payment account number to determine the user's personal information. In some instances, the funding account might only be identified by the device number or identifier.

Bill payment system 201 may process payment requests by transmitting a funds transfer request to financial institution A 205a holding the funding account of the payment device 203a or 203b. The funds transfer request may include identification of payee 207, identification of the payee's financial institution (e.g., financial institution B 205b), payment amount, payment date and the like. Financial institution A 205a may then be configured to determine whether sufficient funds exist in the funding account and if so, initiate payment to the payee 207 directly or via financial institution B 205b. Financial institution B 205b may be configured to receive payment and to provide confirmation of payment to payee 207 and/or to the customer making the payment. Bill payment information such as amount due, due date, previous payment amount and the like might not be stored by the financial institution A 205a or bill payment system 201. Instead, such information may be manually entered by the user. In one or more arrangements, the only bill payment information previously stored by bill payment system 201, financial institution A 205a or the payment device may be payee information (e.g., name, address, etc.) and a billing account (e.g., a payee's financial account to which funds are to be transferred or the payor's account with the payee).

The payment processing environment of FIG. 2 may be used to perform other financial functions including addition of funds onto a payment device (e.g., pre-paid card 203b), withdrawal of cash, purchase of goods or services through a debit transaction and the like. Without having to provide any personal identification information for the pre-paid card or other payment device, individuals may be more willing to transition from using purely cash to card based banking.

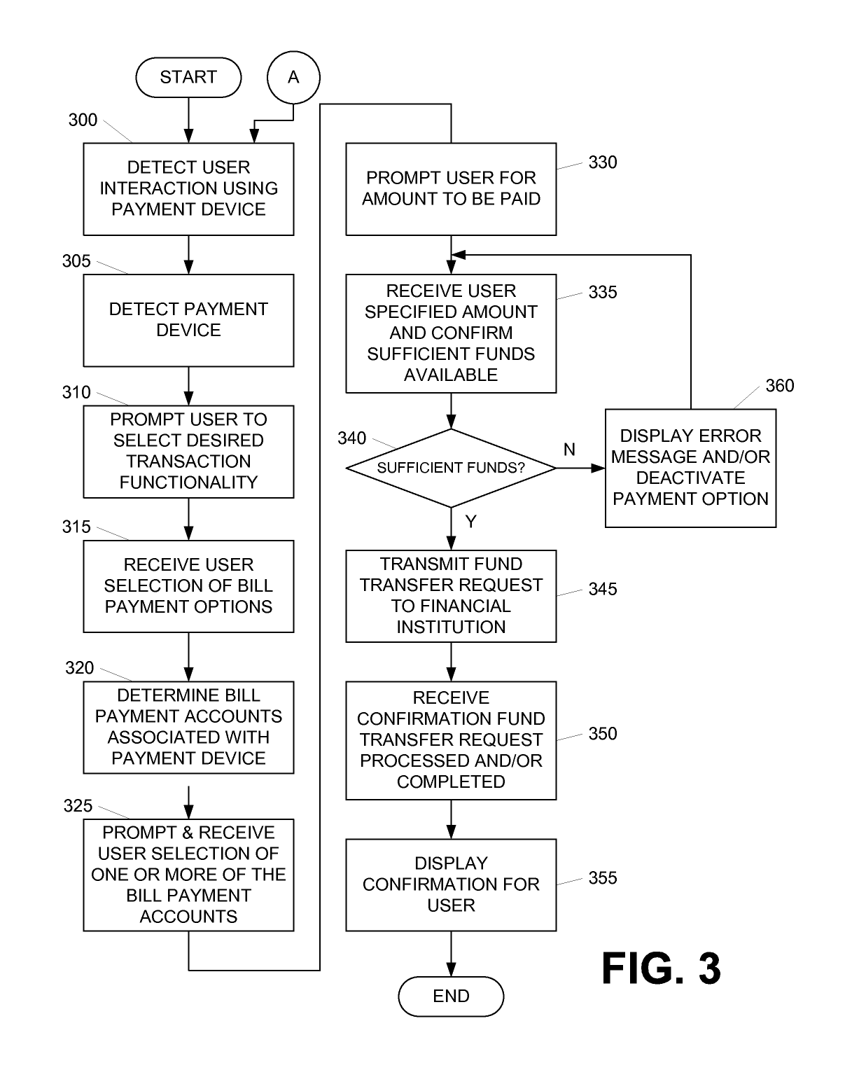

FIG. 3 illustrates a method by which a user may conduct a bill payment transaction using a user generic payment device. In step 300, a user may interact with a bill payment system (e.g., a payment kiosk at a retail location) using a payment device such as a payment card, mobile telephone or the like. In one or more arrangements, the bill payment system may include a personal computer system such as a laptop computer or desktop computer through which a user may pay bills on-line through various payment services. In step 305, the bill payment system may detect the payment device. Detection of the payment device may be performed using various methods including radio frequency ID systems, magnetic readers (e.g., swiping a card having a magnetic strip through a magnetic reader), infrared transmitter/receivers, BLUETOOTH, wireless local area networks (WLAN), wired connections and the like. In some instances, the payment device may transmit payment information in response to a request by the bill payment system. In other configurations, such as those using a magnetic reader, the payment information may be read off of the magnetic strip or recording medium.

In step 310, the bill payment system may prompt the user to select a desired transaction functionality. For example, the system may generate an interface displaying a variety of transaction options including a bill payment option, an add value to card function, a cash withdrawal function, a check balance option and the like. In response to the prompt, the bill payment system may receive a user selection of the bill payment option in step 315. Upon receipt of the user selection in step 315, the bill payment system may determine one or more bill payment accounts associated with the payment device in step 320. Bill payment accounts include accounts for services or goods for which a user has an outstanding balance. The bill payment accounts may be identified based on information stored on the payment device and/or from a remote financial institution or account information system. For example, in one arrangement, bill payment account information including a payee name, address, contact information, financial account information and the like may be stored on the payment device. In another example, the bill payment system may request bill payment account information from a remote financial system based on the card or device number of the payment device. Bill payment system may request bill payment account information from the remote financial system in response to determining that bill payment account information is not stored on the payment device itself. Alternatively or additionally, bill payment account information may be determined through multiple sources (e.g., both the remote financial system and the payment device) substantially simultaneously and/or irrespective of whether bill payment account information is available from one source or the other.

In step 325, the bill payment system may prompt for and receive a user selection of one or more of the bill payment accounts for payment of funds. Upon receiving a user selection of one or more of the bill payment accounts, the bill payment system may prompt the user to enter an amount to be paid for each of the selected accounts in step 330. In step 335, the bill payment system may receive the user specified amount and confirm that the amount is available in the funding account specified by the payment device. If sufficient funds are available, as determined in step 340, the bill payment system may transmit a fund transfer request to a financial institution holding the funding account in step 345. The fund transfer request may specify the amount, payee name or other identification information, payee's financial institution and account information, note to be recorded for the payment and the like. In step 350, the bill payment system may receive confirmation from the financial institution that the fund transfer request has been processed and a transfer has been initiated and/or completed. This confirmation may then be displayed for the user in step 355. The confirmation may indicate that the bill has been paid and provide a confirmation number for the transaction. The confirmation number may be issued by the entity to which the bill is owed (e.g., the payee), the financial institution system or the bill payment system.

Alternatively or additionally, the bill payment system may allow the financial institution to determine whether sufficient funds are available and automatically initiate the funds transfer if sufficient funds are available. As such, the bill payment system may transmit the fund transfer request to the financial institution without making a determination such as that of step 340. If insufficient funds exist in the funding account, the financial institution may notify the bill payment system and reject the funds transfer request.

If sufficient funds are not available for the amount specified by the user, the bill payment system may display an error message to the user and/or deactivate a payment option (e.g., a visual payment option button in an interface) in step 360. Additionally, the user may further be allowed to modify the amount specified in step 335.

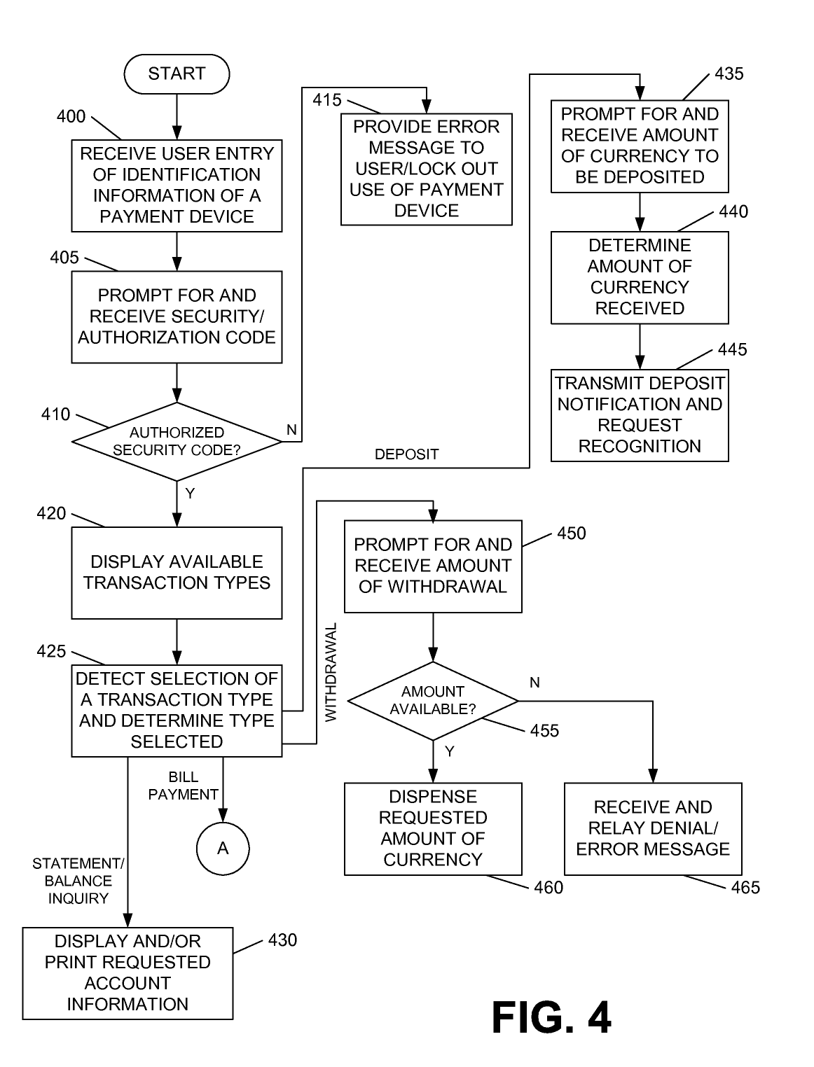

FIG. 4 illustrates a method by which a user may conduct an additional financial transaction using a transaction system such as an automated teller machine (ATM), a payment kiosk, a currency exchange machine, a general computing system and the like. In step 400, the user may enter identification information associated with a payment device. The identification information may be entered by swiping the payment device, placing the payment device in close proximity to a sensor, manual entry of data into an electronic form and the like. In step 405, the transaction system may prompt for and receive user entry of a security code or other identification number to verify that the user is authorized to use the payment device. The security code may be specific and/or unique to the payment device but generic to all users. Alternatively, the security code may be user specific and/or unique. The codes may be stored on the payment device, on the transaction system and/or on a financial institution system of a financial institution holding the funding account associated with the payment device. In step 410, the transaction system may determine if the security code corresponds to an authorized security code for the payment device. If not, the system may provide an error message to the user in step 415. The system may also optionally lock out use of the payment device after a specified number of failed attempts (e.g., 3, 5, 10).

If, on the other hand, the security code is an authorized security code for the payment device, the transaction system may present the user with a menu of available transaction types in step 420. These transaction types may include cash withdrawal, bill payment, funds transfer, cash deposit, check deposit, statement inquiry, balance inquiry and the like. In step 425, the transaction system may detect user selection of a transaction type and determine the transaction type selected. If the selected transaction corresponds to bill payment, the transaction system may, in one or more arrangements, proceed in accordance with the method of FIG. 3. If the selected transaction type corresponds to a balance or statement inquiry, the system may display and/or print the requested information in step 430. Optionally, the system may allow the user to specify one or more inquiry parameters such as a time period, types of transactions to display (versus types of transactions not to display/print), transaction times, transaction locations and/or combinations thereof.

If the user selects a deposit transaction, the transaction system may prompt for and receive an amount of currency from the user in step 435. The transaction system may proceed to determine the amount of currency received in step 440. In one or more configurations, the transaction system may further determine the authenticity of the currency. In step 445, the transaction system may transmit a notification to the financial institution holding the funding account of the deposit and request recognition of the same. The transaction system may subsequently receive an indication of a result of the deposit request (e.g., deposit recognized and/or denied).

If, on the other hand, the user selects a withdrawal transaction, the transaction system may prompt for and receive an amount that the user wishes to withdraw in step 450. The transaction system may then confirm with the financial institution that the requested amount of currency is available in the funding account in step 455. If the funds are available, the transaction system may dispense the requested amount of currency in step 460. If insufficient funds are available, the transaction system may receive an error or denial message from the financial institution and relay the error message to the user in step 465.

Regardless of the type of transaction performed, a record of the transaction may be stored at the financial institution, in the transaction system and/or on the payment device. The transaction record may identify the type of transaction performed, the time of the transaction, amount of the transaction, the location of the transaction and/or combinations thereof.

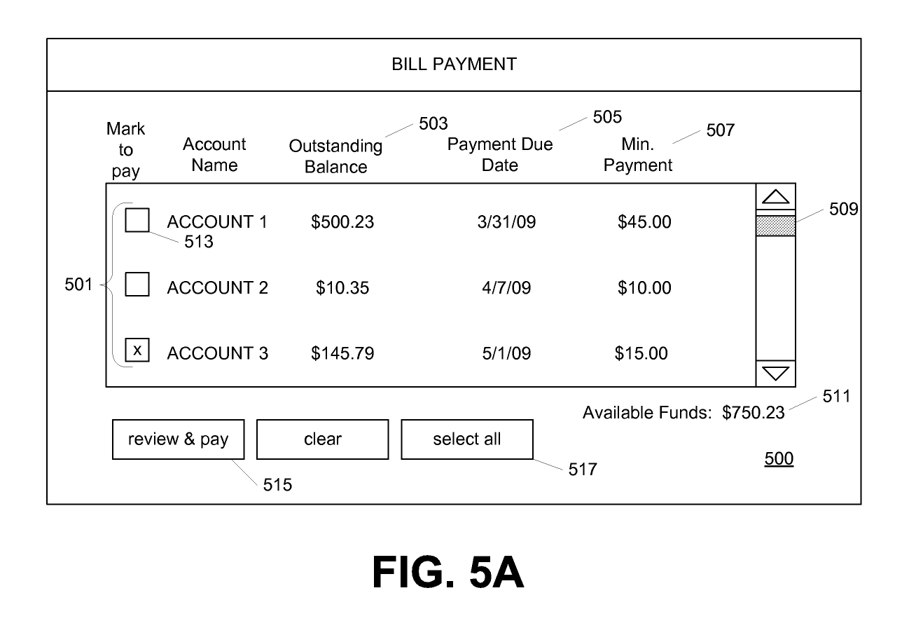

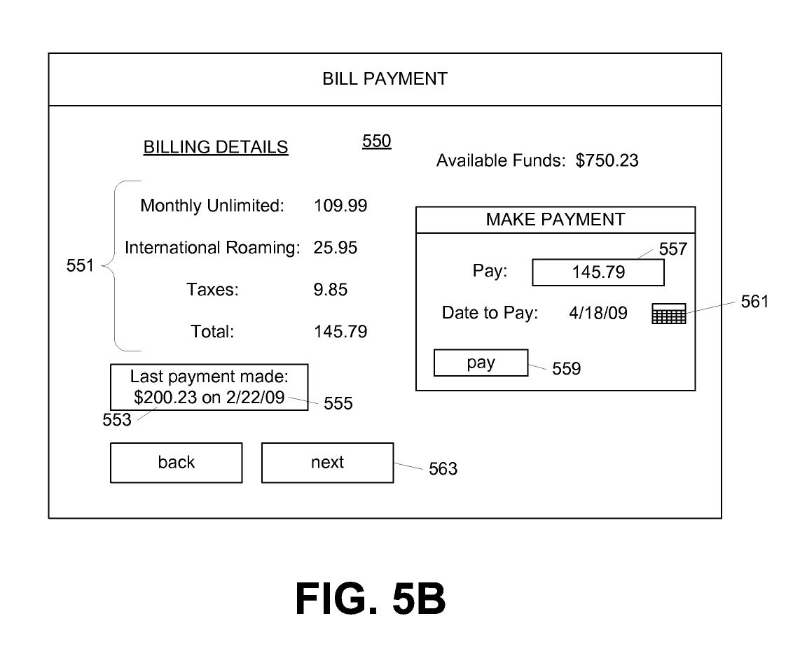

FIGS. 5A and 5B illustrate example interfaces through which a user may conduct a bill payment transaction. In interface 500, for example, a list 501 of bill payment accounts may be displayed. Interface 500 may further include bill information including outstanding balance 503, payment due date 505 and minimum payment due 507. If additional bill payment accounts are available for selection, but do not all fit into a single screen, a scroll option 509 may be displayed. Additionally, interface 500 may display an available balance 511 stored in the funding account of the payment device. To make a payment to a bill payment account, a user may select a field or checkbox 513 positioned next to the desired account. In some arrangements, multiple accounts may be selected at the same time while in other arrangements, only a single account might be selectable. The user may use option 517 to select all accounts without having to individually check each box 513. Once a user has selected desired accounts, the user may select review and pay option 515 to proceed to a subsequent payment screen such as that of FIG. 5B, as further discussed below.

FIG. 5B illustrates interface 550 that may be displayed upon a user selecting a bill payment account from interface 500 of FIG. 5A. Interface 550 may provide more detailed information about a particular bill. For example, interface 550 may display a breakdown 551 of the charges or costs accumulated over the relevant billing period. Interface 550 may further indicate a last payment made 553 and a date thereof 555. The user may enter an amount to pay to the billing entity into field 557 and selecting pay option 559. In one or more arrangements, if the user does not have sufficient funds to pay the entered amount, an error message may be displayed and/or pay option 559 may be deactivated (i.e., made unselectable to the user). Interface 550 may further allow the user to select a time and/or date at which payment is be paid using date selection option 561. Accordingly, the user may choose to schedule a payment one day, two days, one week, one month, etc. in the future. A next option 563 may also be provided, allowing a user to move between selected bill payment accounts if multiple bill payment accounts were selected in interface 500 of FIG. 5A. If multiple bill payment accounts were not selected, next option 563 may be deactivated.

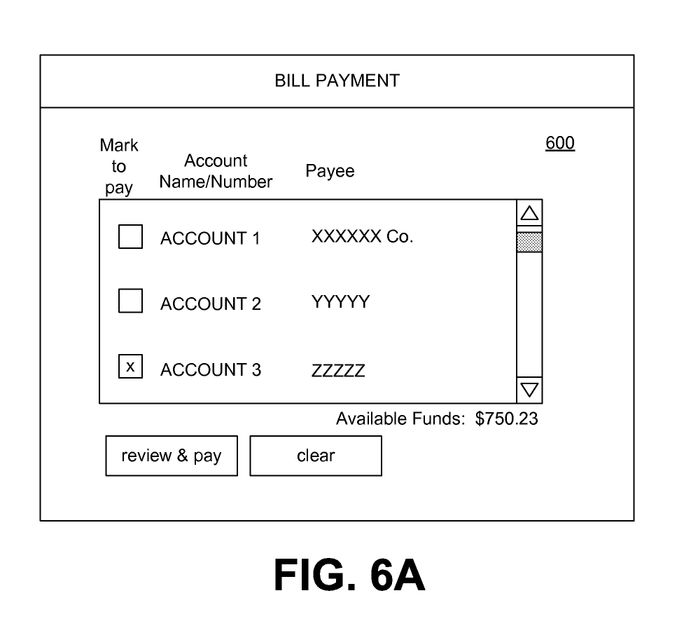

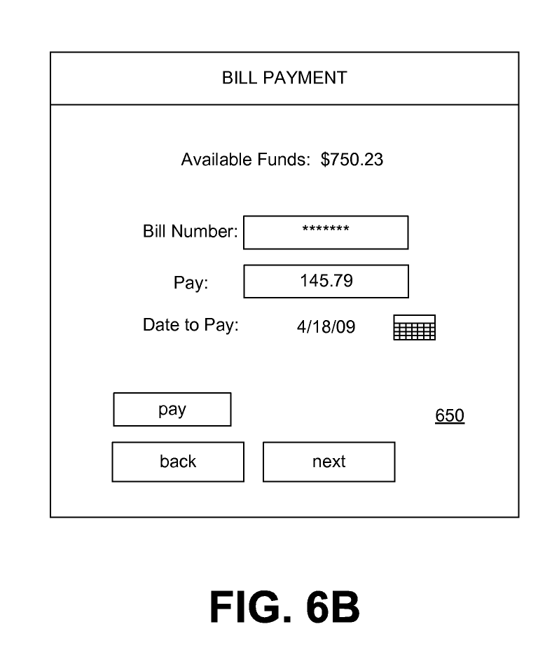

FIGS. 6A and 6B illustrate further example interfaces 600 and 650, respectively, through which a bill payment transaction may be completed. In contrast to the interfaces of FIGS. 5A and 5B, interfaces 600 and 650 may be generated without previous knowledge of bill specifics. For example, interface 600 of FIG. 6A provides an account name or number and payee information (e.g., a name or other identifier). The account number may correspond to the payee's financial account (e.g., to which funds are to be transferred) and/or a user's account with the payee (e.g., for which the bill payment is to be applied). In some arrangements, information for both types of accounts may be previously stored.

FIG. 6B illustrates interface 650 that is configured to prompt the user for billing details including a bill number, an amount to be paid and a payment date. In some arrangements, other information may also be requested including payment due date, amount of previous payment and the like. This information may be used to verify the payor's account with the payee. For example, the payee may check that the amount of previous payment is correct for the specified account before applying the new payment to the account. Additionally or alternatively, billing history and current billing information may be used to find the correct account to which payment is to be applied.

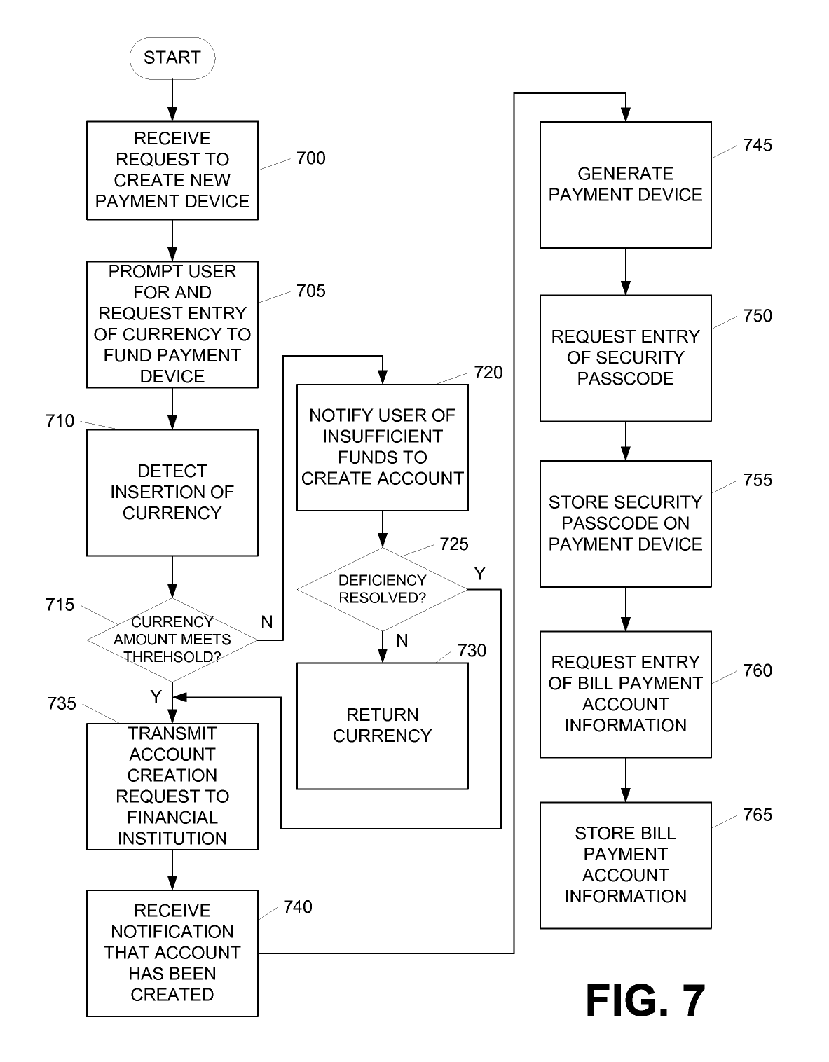

FIG. 7 illustrates an example method by which a payment device associated with a user generic funding account may be created. In step 700, a user may interact with a payment device issuing system by requesting the creation of a new payment device. The payment device issuing system may include a kiosk, a remotely accessible server, a point of sale system or other general computing systems. In step 705, the issuing system may prompt the user for and request entry of currency to fund the funding account of the payment device. In step 710, the issuing system may detect the insertion of currency. In step 715, the issuing system may determine whether the inserted currency meets a threshold minimum for establishing a new payment device and funding account. If not, the issuing system may provide a message to the user indicating that the inserted funds are not sufficient to create new payment device and funding account in step 720. Additionally, the issuing system may identify the amount of the deficiency. If the user chooses not to supply the deficient amount, as determined in step 725, the issuing system may return the inserted currency and decline the payment device creation request in step 730.

If, on the other hand, the amount inserted does meet the threshold minimum or the user supplies the deficient amount, the issuing system may transmit an account creation request to a financial institution system in step 735. The request may indicate a type of account to be opened in addition to the amount deposited. In one example, the type of account may be specified as a debit account with no line of credit or other overdraft or credit available. In some instances, credit might not be available for a payment device or user if user specific/personal information is not provided and/or a credit check performed. In step 740, the issuing system may receive notification that the account has been created with the specified amount of funds.

In step 745, the issuing system may generate a payment device by creating a physical device (e.g., a card or RFID tag) and assigning the device a payment device identification number. For example, the identification number may be randomly generated or generated based on a sequence of already assigned numbers. The issuing system may assign the identification number to the payment device by storing the number in the payment device and transmitting the identification number to the financial institution system for association with the funding account. Additionally, the issuing system may ask the user to enter a security passcode or phrase for use with the payment device in step 750. Upon receipt of the passcode or phrase, the security information may be stored on the payment device in step 755. Alternatively or additionally, the passcode or phrase may be stored at the financial institution system.

In step 7760, the device issuing system may request that the user enter one or more bill payment accounts to be linked to the payment device and/or the underlying funding account. For example, the device issuing system may provide the user with fields or options to enter an account number, a payee, payee contact and payment information (e.g., address, account number) and the like. In one or more examples, entry of payee information may include providing a pre-populated list of known payees from which the user may search and select. Accordingly, if a user is only aware of a payee's name and not the address, financial account or contact information, the user may be able to retrieve this information from payee data already known and stored by a financial institution and/or the device issuing system. Once entered, the device issuing system may store the bill payment account information in association with the payment device in step 7765. As described herein, such information may be stored on the payment device, at a remote system (e.g., a financial institution system) and/or in the issuing system.

According to one or more aspects, contact information may be requested from the user for issuing the payment device. The contact information may include a phone number, an address, an email account or the like so that the financial institution may contact the user in the event the payment device is lost and found by another individual. The issuing system might not require the contact information to be that of the user requesting issuance of the payment device. Alternatively or additionally, entry of contact information may be optional. If no contact information is provided, the financial institution might not be held liable for misuse of a lost or stolen payment device. The owner of the device could still contact the financial institution to have the lost or stolen device deactivated and could have a new device reissued with any remaining funds credited. Any funds spent while the device was lost or stolen might not be reimbursed. By allowing individuals to obtain financial transaction cards without having to provide personal information and/or to prove credit worthiness, such individuals may be more willing to convert from pure cash based transactions to card based banking.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

1. A method comprising:
detecting, by a bill payment system, insertion of a banking card;
determining an account number associated with the banking card, wherein the account number of the banking card is card-specific and user generic;
determining one or more bill payment accounts associated with the account number; and
generating a user interface displaying the one or more bill payment accounts, wherein the user interface allows selection of the one or more bill payment accounts for payment of a bill.

2. The method of claim 1, wherein an account associated with the account number only stores non-user identification information.

3. The method of claim 2, wherein the account associated with the account number stores an amount of available funds remaining.

4. The method of claim 1, wherein an account associated with the account number disallows overdrafting.

5. The method of claim 1, further comprising:
receiving a selection of a bill payment account from the displayed one or more bill payment accounts; and
generating an electronic payment transaction to pay an amount owed for the bill payment account using available funds in an account specified by the account number.

6. The method of claim 5, further comprising retrieving bill payment account information from a financial institution system of a financial institution holding an account specified by the account number, wherein the bill payment account information includes payee information and wherein the financial institution system is located remotely from the bill payment system.

7. The method of claim 1, wherein the banking card is a pre-paid card.

8. A method comprising:
detecting, by a bill payment system, use of a payment device;
determining an account number associated with the payment device, wherein the account number of the payment device is device-specific and user generic;
determining one or more bill payment accounts associated with the account number; and
generating a user interface displaying the one or more bill payment accounts, wherein the user interface allows selection of the one or more bill payment accounts for payment of a bill.

9. The method of claim 8, wherein information identifying the one or more bill payment accounts is stored in the payment device.

10. The method of claim 8, wherein information identifying the one or more bill payment accounts is stored in a remote server.

11. The method of claim 8, further comprising:
receiving a selection of a bill payment account from the displayed one or more bill payment accounts; and
generating an electronic payment transaction to pay an amount owed for the bill payment account using available funds in an account specified by the account number.

12. The method of claim 8, wherein an account associated with the account number only stores non-user identification information.

13. The method of claim 8, further comprising:
receiving a selection of a bill payment account from the one or more bill payment accounts;
completing a transaction including payment of at least a portion of an outstanding balance associated with the bill payment account; and
storing a record of the transaction.

14. The method of claim 13, wherein the record of the transaction is stored in the payment device.

15. The method of claim 13, further comprising:
receiving a user specification of an amount to be paid to the bill payment account;
determining whether an amount of funds available in a funding account associated with the payment device is equal to or greater than the user specified amount to be paid; and
in response to determining that the amount of funds available is not equal to or greater than the user specified amount to be paid, deactivating a payment submission option.

16. One or more non-transitory computer readable media storing computer readable instructions that, when executed, cause an apparatus to:
detect, by a bill payment system, use of a payment device;
determine an account number associated with the payment device, wherein the account number of the payment device is device-specific and user generic;
determine one or more bill payment accounts associated with the account number; and
generate a user interface displaying the one or more bill payment accounts, wherein the user interface allows selection of the one or more bill payment accounts for payment of a bill.

17. The one or more computer readable media of claim 16, wherein information identifying the one or more bill payment accounts is stored in the payment device.

18. The one or more computer readable media of claim 16, wherein information identifying the one or more bill payment accounts is stored in a remote server.

19. The one or more computer readable media of claim 16, further comprising instructions for:
receiving a selection of a bill payment account from the displayed one or more bill payment accounts; and
generating an electronic payment transaction to pay an amount owed for the bill payment account using available funds in an account specified by the account number.

20. The one or more computer readable media of claim 16, further comprising instructions for:
receiving a selection of a bill payment account from the one or more bill payment accounts;
completing a transaction including payment of at least a portion of an outstanding balance associated with the bill payment account; and
storing a record of the transaction.

21. The one or more computer readable media of claim 16, wherein the computer readable instructions, when executed, further cause the apparatus to:
generate a user interface displaying a plurality of transaction options including one or more of: cash withdrawal, cash deposit, check deposit, debit transaction for purchases.
